(19) United States
(12) Patent Application Publication
(10) Pub. No.: US 2026/0198569 A1
(43) Pub. Date: Jul. 16, 2026

(54) AEROSOL-GENERATING ARTICLE WITH A PLANAR FRAME

(71) Applicant: Philip Morris Products S.A., Neuchatel (CH)

(72) Inventors: Rui Nuno Rodrigues Alves BATISTA, Morges (CH); Semen GURALEVYCH, Lausanne (CH)

(73) Assignee: Philip Morris Products S.A., Neuchatel (CH)

(21) Appl. No.: 19/136,923

(22) PCT Filed: Dec. 21, 2023
(86) PCT No.: PCT/EP2023/087357

§ 371 Date: Jun. 9, 2025

(30) Foreign Application Priority Data
Dec. 23, 2022 (EP) 22216422.0

(51) Int. Cl. A24F 40/42; A24F 40/30; A24F 40/485; H05B 3/20

(52) U.S. Cl. CPC A24F 40/42; A24F 40/30; A24F 40/485; H05B 3/20

(57) ABSTRACT

An aerosol-generating article for an aerosol-generating device to form an inhalable aerosol is provided, article including: a planar frame including planar upper and lower surfaces, and lateral sides extending between the planar upper and lower surfaces; an air inlet and aerosol outlet; an aerosolisation cavity between the inlet and the outlet; an aerosol-generating substrate located in the cavity, in contact with the planar lower surface of the planar frame and spaced from the planar upper surface of the planar frame to define an air gap between an upper surface of the substrate and the planar upper surface of the planar frame, the air gap having a depth of between approximately 0.1 mm and approximately 1 mm and extending over substantially all of the upper surface of the aerosol-generating substrate; and an airflow channel extending from the inlet to the outlet, passing through the air gap.

The disclosure relates to an aerosol-generating article and an aerosol-generating system comprising an aerosol-generating device and an aerosol-generating article.

Some known aerosol-generating systems comprise an aerosol-generating device having a power supply, such as a battery, a controller, and a heating element for heating an aerosol-generating substrate. In some examples, the aerosol-generating substrate comprises a tobacco rod or a tobacco plug that is arranged in an aerosol-generating article. In use, the aerosol-generating article is inserted into a cavity of the aerosol-generating device, and the heating element either penetrates the aerosol-generating substrate or is arranged around the outside of the aerosol-generating substrate. Power is supplied to the heating element from the power supply to heat the aerosol-generating substrate, and volatile components of the aerosol-generating substrate are vaporised and released and condense to form an aerosol, which is inhalable by a user. In some such aerosol-generating systems, the aerosol-generating article resembles a conventional cigarette, having a similar cylindrical stick like configuration.

This known aerosol-generating article has various limitations and inefficiencies.
1) It typically requires large volumes of aerosol-generating substrate, in order to provide a required amount of aerosol while having a suitable porosity and retention to draw.
2) The temperature and airflow profile through the aerosol-generating substrate means that upstream and downstream portions of aerosol-generating substrate are exposed to different temperatures in use.
3) Energy is lost due to a temperature decrease of aerosol-generating substrate from cold fresh air passing through the aerosol-generating substrate. Specifically, the aerosol-generating substrate temperature should be set at a temperature for aerosolisation. However, when there is air intake through the aerosol-generating article caused by the user, fresh air at high-speed flows throughout the aerosol-generating substrate portion(s) which decreases the aerosol-generating substrate temperature. This reduces the rate of aerosol generation from the aerosol-generating substrate. In one known system, this decrease of temperature can be detected by a control unit of the device that responds powering the heating element. However, there is a delay between the temperature of the aerosol-generating substrate decreasing, and the action of powering the heating element to heat the aerosol-generating substrate, which affects aerosolisation of the aerosol inhaled in that specific moment. This results in a loss of energy, leading to ineffective energy management of aerosolisation and of the system.
4) Where upstream and downstream portions of aerosol-generating substrate differ from each other, for example one having a different composition to the other, an upstream portion can contaminate a downstream portion in use. This is because external fresh air feeds aerosolisation of an upstream aerosol-generating substrate portion, and the generated aerosol feeds aerosolisation of the subsequent downstream aerosol-generating substrate portion(s). As such, it is only the upstream portion of aerosol-generating substrate which receives fresh air providing a predictable, pure, aerosolisation outcome in terms of the aerosol content, taste, and any aromatic notes. Subsequent downstream aerosol-generating substrate portions can become contaminated with upstream aerosol. This leads to a requirement for complex management of the taste and aroma of the final aerosol leaving the aerosol-generating article.
5) Complex product design is required, to define an appropriate aerosol-generating substrate porosity and volume. The porosity of the aerosol-generating substrate has to be defined to enable an adequate speed and volume of air flow. This is related to the retention to draw, which is designed to be equal to or greater than the optimal retention to draw so that fresh air can timely flush and blend with aerosol produced by the aerosol-generating substrate. This is related to the volume of aerosol-generating substrate and its dimensions, limiting the range of suitable dimensions for the aerosol-generating substrate.

It would be desirable to provide an improved aerosol-generating article for use with an aerosol-generating device.

According to the disclosure there is provided an aerosol-generating article for use with an aerosol-generating device to form an inhalable aerosol. The aerosol-generating article may comprise a planar frame. The planar frame may comprise a planar upper surface. The planar frame may comprise a planar lower surface. The planar frame may comprise lateral sides. The lateral sides may extend between the planar upper surface and the planar lower surface. The aerosol-generating article may comprise an air inlet. The aerosol-generating article may comprise an aerosol outlet. The aerosol-generating article may comprise an aerosolisation cavity. The aerosolisation cavity may be between the air inlet and the aerosol outlet. The aerosol-generating article may comprise an aerosol-generating substrate. The aerosol-generating substrate may be located in the aerosolisation cavity. The aerosol-generating substrate may be in contact with the planar lower surface of the planar frame. The aerosol-generating substrate may be spaced from the planar upper surface of the planar frame. The aerosol-generating substrate may be spaced from the planar upper surface of the planar frame to define an air gap between an upper surface of the aerosol-generating substrate and the planar upper surface of the planar frame. The aerosol-generating article may comprise an airflow channel extending from the air inlet to the aerosol outlet. The airflow channel may pass through the air gap.

According to the disclosure there is provided an aerosol-generating article for use with an aerosol-generating device to form an inhalable aerosol, the aerosol-generating article comprising:
a planar frame comprising a planar upper surface, a planar lower surface and lateral sides extending between the planar upper surface and the planar lower surface;
an air inlet and an aerosol outlet;
an aerosolisation cavity between the air inlet and the aerosol outlet;
an aerosol-generating substrate located in the aerosolisation cavity, in contact with the planar lower surface of the planar frame and spaced from the planar upper surface of the planar frame to define an air gap between an upper surface of the aerosol-generating substrate and the planar upper surface of the planar frame; and
an airflow channel extending from the air inlet to the aerosol outlet, passing through the air gap.

This aerosol-generating article has various advantages.
1) The volume of aerosol-generating substrate required is reduced, as air can flow over a large surface of the aerosol-generating substrate. Specifically, air flow over the aerosol-generating substrate through the air gap provides a large surface area of the aerosol-generating substrate in contact with the air flow channel.
2) An improved temperature profile through the aerosol-generating substrate is provided, as upstream and downstream portions of aerosol-generating substrate can be exposed to substantially the same temperatures in use as each other. An improved temperature profile through the aerosol-generating substrate is also provided because there is a reduction in cooling of the aerosol-generating substrate by airflow through the aerosol-generating article because air is not required to flow through the aerosol-generating substrate.
3) Aerosol generated by an upstream portion of aerosol-generating substrate does not need to pass through a downstream portion of aerosol-generating substrate. Equally, a heated aerosol does not need to pass through unheated aerosol-generating substrate to reach the aerosol outlet. This reduces self-filtration of the aerosol by downstream aerosol-generating substrate, improving the quality of the aerosol at the aerosol outlet.
4) Where upstream and downstream portions of aerosol-generating substrate differ from each other, for example one having a different composition to the other, contamination of the downstream portion by the upstream portion is reduced or removed, because air does not need to flow through the downstream portion after flowing through the upstream portion. Where upstream and downstream portions of aerosol-generating substrate differ from each other, aerosol from each portion can be blended in a downstream portion of the airflow channel.
5) The temperature of the aerosol-generating substrate is less affected by air flowing through the aerosol-generating article. The rate of aerosol generation is not dependent on or limited by the rate of airflow through the aerosol-generating article. Specifically, there is no strong direct correlation between: a) the temperature of the aerosol-generating substrate, which can be in direct contact with and be heated by a planar heating element(s) on a lower surface causing the release of volatiles and aerosol on an upper surface, and b) the fresh air flushing the aerosol away from the upper surface is driven by the puff of the user. This allows for particularly advantageous air flow management.
6) The aerosol-generating article has a simple design, incorporating few parts.

As used herein, “planar” refers to a feature generally formed in a single Euclidean plane and not wrapped around or otherwise conformed to fit a curved or other non-planar shape. A planar surface extends in two dimensions in a single Euclidean plane. A planar object extends in two dimensions in a single Euclidean plane substantially more than in a third dimension perpendicular to the plane. More specifically, a planar object extends in a first dimension and a second dimension perpendicular to the first dimension at least two, five or ten times further than the object extends in a third dimension perpendicular to the first and second dimensions.

As used herein, “aerosol-generating device” refers to a device that interacts with an aerosol-generating substrate to generate an aerosol.

As used herein, “aerosol-generating substrate” refers to a substrate capable of releasing volatile compounds that can form an aerosol. Such volatile compounds may be released by heating the aerosol-generating substrate. An aerosol-generating substrate is typically part of an aerosol-generating article.

As used herein, “aerosol-generating article” refers to an article comprising an aerosol-generating substrate that is capable of releasing volatile compounds that can form an aerosol. For example, an aerosol-generating article may be an article that generates an aerosol that is directly inhalable by the user drawing on a mouthpiece at a proximal or mouth end of the aerosol-generating article, an aerosol-generating device, or an aerosol-generating system. An aerosol-generating article may be disposable.

As used herein, “aerosol-generating system” refers to the combination of an aerosol-generating device with an aerosol-generating article. In an aerosol-generating system, the aerosol-generating article and the aerosol-generating device co-operate to generate an aerosol.

As used herein, “proximal” refers to a user end, or mouth end of the aerosol-generating device, aerosol-generating article, or aerosol-generating system. The proximal end of a component of an aerosol-generating device, an aerosol-generating article, or an aerosol-generating system is the end of the component closest to the user end, or mouth end of the aerosol-generating device, the aerosol-generating article, or the aerosol-generating system. As used herein, “distal” refers to the end opposite the proximal end.

As used herein, “end” and “side” are used interchangeably to refer to extremities of a feature, such as an aerosol-generating device, a heating assembly, a heating element, or an aerosol-generating article. Preferably, features described herein have two opposing ends and at least one side extending between the two opposing ends. Preferably, features described herein have a length extending in a longitudinal direction between opposing ends, and a width extending in a transverse direction between two opposing sides.

As used herein, “upper surface” and “lower surface” are relative terms used to refer to opposing surfaces of a feature, such as an aerosol-generating device, a heating assembly, a heating element, an aerosol-generating article, or a planar frame. The upper surface can be located above the lower surface during normal use of the feature, though it will be appreciated that alternative orientations of the feature during use are possible.

As used herein, “length” refers to the maximum dimension of a feature in a longitudinal direction of the feature.

As used herein, “width” refers to the maximum dimension of a feature in a transverse direction of the feature. The transverse direction is perpendicular to the longitudinal direction.

As used herein, “thickness” and “depth” refer to the maximum dimension of a feature in a direction perpendicular to the longitudinal direction of the feature and perpendicular to the transverse direction of the feature. The terms “thickness” and “depth” may be used interchangeably herein.

As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-generating substrate or aerosol-generating article. Suitable aerosol formers for inclusion in the first and second aerosol-generating substrates are known in the art and include, but are not limited to: polyhydric alcohols, such as triethylene glycol, propylene glycol, 1,3-butanediol and glycerol; esters of polyhydric alcohols, such as glycerol mono-, di-or triacetate; and aliphatic esters of mono-, di-or polycarboxylic acids, such as dimethyl dodecanedioate and dimethyl tetradecanedioate. Glycerol may be particularly preferable as an aerosol former. Aerosol former contents described with respect to the first and second aerosol-generating substrates may equally be considered glycerol contents.

As used herein, the term “aerosol former content” may refer to aerosol former content in percent on a dry weight basis, unless otherwise specified.

As used herein, the terms “upstream” and “downstream” may refer to the relative positions of elements, or portions of elements, in relation to the direction in which the air or aerosol is transported through the aerosol-generating article during use.

At least 50 weight percent of the aerosol-generating article may be paper or cardboard. At least 55 weight percent, or at least 60 weight percent, or at least 65 weight percent, or at least 70 weight percent, or at least 75 weight percent, or at least 80 weight percent, or at least 85 weight percent, or at least 90 weight percent of the aerosol-generating article, excluding the aerosol-forming substrate, may be paper or cardboard.

The airflow channel may be defined between the aerosol-generating substrate and the planar upper surface of the planar frame.

The airflow channel may pass between the aerosol-generating substrate and at least one of the lateral sides of the planar frame. This has the advantage of providing improved aerosol quality at the aerosol outlet. The airflow channel may pass between the aerosol-generating substrate and at least two opposing lateral sides of the planar frame. There may be a lateral gap between the aerosol-generating substrate and at least one of the lateral sides of the planar frame. The airflow channel may pass through the lateral gap.

The airflow channel may have an airflow channel depth between the planar upper surface and the planar lower surface of the planar frame. The airflow channel depth may be at least about 0.3 millimetres. The airflow channel depth may be at most about 5.5 millimetres. The airflow channel depth may be between about 0.3 millimetres and about 5.5 millimetres. The airflow channel may have a width between opposing lateral sides of the planar frame, the width being between 5 millimetres and 15 millimetres.

The aerosol-generating substrate may have an outer surface. The outer surface may be an outermost surface extending around the entire aerosol-generating substrate. The outer surface may include an upper surface, a lower surface, and lateral sides of the aerosol-generating substrate. At least 50% of the outer surface of the aerosol-generating substrate may be in contact with the airflow channel. This has the advantage of providing more efficient aerosol generation. Preferably, at least 60% of the outer surface of the aerosol-generating substrate may be in contact with the airflow channel.

The airflow channel may be aligned with the upper surface of the planar frame. This has the advantage of providing a compact aerosol-generating article. The airflow channel may be parallel to the upper surface of the planar frame.

The airflow channel may be aligned with an upper surface of the aerosol-generating substrate. This has the advantage of efficient aerosol generation. The airflow channel may be parallel to the upper surface of the aerosol-generating substrate. The airflow channel may be configured so that air flow through the aerosolisation cavity is substantially parallel to an upper surface of the aerosol-generating substrate. The airflow channel may be configured so that air flow through the aerosolisation cavity is substantially perpendicular to the direction of aerosol leaving the aerosol-generating substrate.

The airflow channel may be configured such that air flow through the aerosol-generating article flows from the air inlet, over an upper surface of the aerosol-generating substrate, to the aerosol outlet. The airflow channel may be configured such that a majority of air flow through the aerosol-generating article flows from the air inlet, over an upper surface of the aerosol-generating substrate, to the aerosol outlet.

The retention to draw of the aerosol-generating article may be defined by the air flow rate through the air flow channel. The retention to draw of the aerosol-generating article may be between 50 and 220 mm H₂O. The retention to draw of the aerosol-generating article is preferably between 70 and 140 mm H₂O.

The air gap may have a depth of at least approximately 0.1 millimetres. This has the advantage of providing suitable air flow through the aerosol-generating article. Preferably the air gap has a depth of at least approximately 0.2 millimetres. The air gap may have a depth of at most approximately 1 millimetre. This has the advantage of providing a compact aerosol-generating article. Preferably air gap has a depth of at most approximately 0.6 millimetres. The air gap may have a depth of approximately 0.2 millimetres. Preferably the air gap has a depth of approximately 0.4 millimetres. More preferably the air gap has a depth of approximately 0.5 millimetres.

The air gap may extend over substantially all of the upper surface of the aerosol-generating substrate. The aerosol-generating substrate may be spaced from the planar upper surface to define the air gap across an entire upper surface of the aerosol-generating substrate. The aerosol-generating substrate may not be in contact with the planar upper surface.

The air gap may have a substantially constant depth over the upper surface of the aerosol-generating substrate.

The planar frame may have a width, a depth and a length, the length being greater than the width, and the width being greater than the depth. The thickness may be no more than 0.5 times the length. The thickness may be no more than 0.5 times the width.

The planar frame may be substantially flat. The planar frame may be substantially elongate. The planar frame may have at least two substantially parallel lateral sides. The planar frame may have a substantially parallelepiped shape. The planar frame may have a length, a width and a depth. The length may be bigger than each of the width and the depth. The planar frame may be elongate along a frame length. The planar frame may have a rectangular cross-section. The planar frame may have a rectangular lateral cross-section, the lateral cross-section being aligned with the frame width and the frame thickness. A longitudinal axis along the length of the frame may be a normal to a plane of the lateral cross-section.

The air inlet and the aerosol outlet may be disposed at opposite ends of the length of the frame. The air inlet may be disposed at an upstream end of the frame. The air inlet may be disposed at a distal end of the frame. The aerosol outlet may be disposed at a downstream end of the frame. The aerosol outlet may be disposed at a proximal end of the frame. The air inlet may be disposed at an end of the frame which is perpendicular to the length of the frame. The aerosol outlet may be disposed at an end of the frame which is perpendicular to the length of the frame. The frame may have a longitudinal axis. The longitudinal axis may be a central axis aligned with a length of the frame. The air inlet may be intersected by the longitudinal axis. The air inlet may be arranged so that the longitudinal axis intersects a central point of the inlet. The inlet may be offset from the longitudinal axis. The aerosol outlet may be intersected by the longitudinal axis. The aerosol outlet may be arranged so that the longitudinal axis intersects a central point of the aerosol outlet. The aerosol outlet may be offset from the longitudinal axis. The air inlet may be offset from the outlet.

A ratio of the planar frame width to the planar frame thickness may be at least about 3:1. A ratio of the planar frame width to the planar frame thickness may be at most about 30:1. A ratio of the planar frame width to the planar frame thickness may be between about 3:1 and about 30:1. A ratio of the planar frame width to the planar frame thickness may be about 30:3. A ratio of the planar frame length to the planar frame width may be at least about 1:1. A ratio of the planar frame length to the planar frame width may be at most about 5:1. A ratio of the planar frame length to the planar frame width may be between about 1:1 and about 5:1. A ratio of the planar frame length to the frame width may be about 5:1.

The planar frame may have a thickness of at least about 1 millimetre. The planar frame may have a thickness of at most about 3 millimetres. The planar frame may have a thickness of between about 1 millimetre and about 3 millimetres. The planar frame may have a width of at least about 10 millimetres. The planar frame may have a width of at most about 30 millimetres. The planar frame may have a width of between about 10 millimetres and about 30 millimetres. The planar frame may have a length of at least about 30 millimetres. The planar frame may have a length of at most about 50 millimetres. The planar frame may have a length of between about 30 millimetres and about 50 millimetres.

The lateral sides may be lateral side walls. The lateral side walls may together form a perimeter wall.

The lateral side walls may extend from the planar lower surface in a thickness direction of the planar frame. The lateral side walls may be aligned along an outer edge of the planar lower surface. The lateral side walls may be aligned along all sides and ends of the planar lower surface. When the planar lower surface is rectangular, the lateral side walls may be aligned along one or both ends of the planar lower surface. When the planar lower surface is rectangular, the lateral side walls may be aligned along one or both sides of the planar lower surface. The lateral side walls may be located at an outer edge of the planar lower surface. The lateral side walls may extend along a circumference of the planar lower surface. The lateral side walls may extend along a majority of a circumference of the planar lower surface. The lateral side walls may extend along all of the circumference of the planar lower surface which is not occupied by the inlet or the outlet.

The lateral side walls may comprise or consist of cellulose material or a cellulose-based material. The lateral side walls may comprise or consist of a paper-based material. The cellulose material may be one or more of: paper, cellulose acetate. The lateral side walls may comprise one or more of: a porous or fibrous material, cellulose acetate, synthetic fibers, polyester, bonded polyolefin, polyethylene, terylene, polyethylene terephthalate, polypropylene, a biopolymer, biopolymer fibres, polyamide, nylon, nylon fibres, a ceramic, ceramic fibres.

The lateral side walls may have a thickness in a depth direction. The lateral side wall thickness may be at least about 1 millimetre. The lateral side wall thickness may be at most about 3 millimetres. The lateral side wall thickness may be between about 1 millimetre and about 5 millimetres. The lateral side walls may have a length of at least about 30 millimetres in a length direction of the aerosol-generating article. The lateral side walls may have a length of at most about 50 millimetres in a length direction of the aerosol-generating article. The lateral side walls may have a length of between about 30 millimetres and about 50 millimetres in a length direction of the aerosol-generating article. The lateral side walls may have a width of at least about 10 millimetres in a width direction of the aerosol-generating article. The lateral side walls may have a width of at most about 30 millimetres in a width direction of the aerosol-generating article. The lateral side walls may have a width of between about 10 millimetres and about 30 millimetres in a width direction of the aerosol-generating article.

The air inlet and the aerosol outlet may be apertures disposed in the lateral side walls.

The lateral side walls may comprise: a proximal lateral side wall, a distal lateral side wall, and first and second lateral side walls. The proximal and distal lateral side walls may be substantially parallel to each other. The first and second lateral side walls may be substantially parallel to each other. The first and second lateral side walls may extend between the proximal lateral side wall and the distal lateral side wall. The air inlet may be disposed in the distal lateral side wall. The aerosol outlet may be disposed in the proximal lateral side wall.

The lateral side walls may have an inner shape that is substantially the same as an outer edge or outer edges of the aerosol-generating substrate. The lateral side walls may have an inner shape that is larger than an outer edge of the aerosol-generating substrate. There may be a lateral gap between the lateral side walls and an outer edge of the aerosol-generating substrate. There may be a lateral gap between the perimeter wall and all outer edges of the aerosol-generating substrate. The perimeter wall may contour an outer edge or outer edges of the aerosol-generating substrate. The perimeter wall may comprise a first section and a second section, which may be separated from each other by the air inlet and the aerosol outlet.

The planar lower surface may be substantially rectangular. The planar lower surface may be elongate. The planar lower surface may be a layer of material. The planar lower surface may comprise an impermeable material. The planar lower surface may comprise a biodegradable material. The planar lower surface may comprise or consist of cellulose material. The cellulose material may be one or more of: paper, cellulose acetate. The planar lower surface may comprise or consist of a paper-based material. The planar lower surface may comprise or consist of paper. The planar lower surface may be a layer of paper. The planar lower surface may comprise one or more of: paper, a paper-based material, plastic, polyethylene, terylene, polyethylene terephthalate, or polypropylene.

The planar lower surface may have a length of at least about 30 millimetres. The planar lower surface may have a length of at most about 50 millimetres. The planar lower surface may have a length of between about 30 millimetres and about 50 millimetres. The planar lower surface may have a width of at least about 10 millimetres. The planar lower surface may have a width of at most about 30 millimetres. The planar lower surface may have a width of between about 10 millimetres and about 30 millimetres. The planar lower surface may be a planar lower wall. The planar lower wall may have a thickness in a depth direction. The thickness may be at least about 0.05 millimetres. The thickness may be at most about 0.1 millimetres. The thickness may be between about 0.05 millimetres and about 0.1 millimetres.

The planar upper surface may be a planar upper wall. The planar upper surface may have any of the features listed for the planar lower surface. The planar upper surface may be substantially the same shape, size, material, orientation, length, width, or thickness, as the planar lower surface.

The lateral side walls may have a thickness in the depth direction. The planar lower surface thickness or the planar upper surface thickness may be substantially less than the lateral side wall thickness. The planar lower surface may be fixedly attached to the lateral side walls. The planar upper surface may be fixedly attached to the lateral side walls. The planar lower surface may be sealed to the lateral side walls. The planar upper surface may be sealed to the lateral side walls. The planar lower surface may be hermetically sealed to the lateral side walls. The planar upper surface may be hermetically sealed to the lateral side walls.

The air inlet may have a length of at least about 10 millimetres. The air inlet may have a length of at most about 20 millimetres. The air inlet may have a length of between about 10 millimetres and about 20 millimetres. The air inlet may have a width of at least about 10 millimetres. The air inlet may have a width of at most about 20 millimetres. The air inlet may have a width of between about 10 millimetres and about 20 millimetres. The air inlet may have a depth of at least about 3 millimetres. The air inlet may have a depth of at most about 7 millimetres. The air inlet may have a depth of about 5 millimetres.

The aerosol outlet may have a length of at least about 10 millimetres. The aerosol outlet may have a length of at most about 20 millimetres. The aerosol outlet may have a length of between about 10 millimetres and 20 millimetres. The aerosol outlet may have a width of at least about 10 millimetres. The aerosol outlet may have a width of at most about 20 millimetres. The aerosol outlet may have a width of between about 10 millimetres and 20 millimetres. The aerosol outlet may have a depth of at least about 3 millimetres. The aerosol outlet may have a depth of at most about 7 millimetres. The aerosol outlet may have a depth of about 5 millimetres.

The aerosol outlet may be a mouthpiece of the aerosol-generating article. The aerosol outlet may be shaped so as to create a Venturi effect.

The aerosolisation cavity may have a width between opposing lateral sides of the planar frame, the width being between 5 millimetres and 15 millimetres. The aerosolisation cavity may have a length of between 15 millimetres and 45 millimetres. The aerosolisation cavity may be substantially enclosed by the planar frame.

The depth of the aerosolisation cavity may be equal to the thickness of the lateral side walls. The aerosolisation cavity depth may be at least about 1 millimetre. The aerosolisation cavity depth may be at most about 3 millimetres. The aerosolisation cavity depth may be between about 1 millimetre and about 3 millimetres.

The aerosolisation cavity may be elongate. The aerosolisation cavity may be planar. The aerosolisation cavity may define a substantially rectangular longitudinal cross-section. The aerosolisation cavity may define a substantially rectangular lateral cross-section. The aerosolisation cavity may be defined by the lateral side walls.

The aerosol-generating substrate may have a thickness of at least about 0.1 millimetres. The aerosol-generating substrate may have a thickness of at most about 5 millimetres. The aerosol-generating substrate may have a thickness of between about 0.1 millimetres and about 5 millimetres. The aerosol-generating substrate may have a width of at least about 10 millimetres. The aerosol-generating substrate may have a width of at most about 20 millimetres. The aerosol-generating substrate may have a width between about 10 millimetres and about 20 millimetres. The aerosol-generating substrate may have a length of at least about 20 millimetres. The aerosol-generating substrate may have a length of at most about 40 millimetres. The aerosol-generating substrate may have a length between about 20 millimetres and about 40 millimetres.

The aerosol-generating substrate may have a density greater than or equal to 0.3 grams per cubic centimetre. The aerosol-generating substrate may have a density greater than or equal to 0.4 grams per cubic centimetre. The aerosol-generating substrate may have a density greater than or equal to 0.5 grams per cubic centimetre. The aerosol-generating substrate may have a density greater than or equal to 0.6 grams per cubic centimetre. The aerosol-generating substrate may have a density greater than or equal to 0.7 grams per cubic centimetre. The aerosol-generating substrate may have a density less than or equal to 0.8 grams per cubic centimetre.

The aerosol-generating substrate may have a density less than or equal to 1.0 grams per cubic centimetre. The aerosol-generating substrate may have a density less than or equal to 0.9 grams per cubic centimetre. The aerosol-generating substrate may have a density less than or equal to 0.8 grams per cubic centimetre. The aerosol-generating substrate may have a density less than or equal to 0.7 grams per cubic centimetre. The aerosol-generating substrate may have a density less than or equal to 0.6 grams per cubic centimetre. The aerosol-generating substrate may have a density less than or equal to 0.5 grams per cubic centimetre. The aerosol-generating substrate may have a density less than or equal to 0.4 grams per cubic centimetre.

The aerosol-generating substrate may have a density between 0.3 grams per cubic centimetre and 1.3 grams per cubic centimetre. The aerosol-generating substrate may have a density between 0.3 grams per cubic centimetre and 1.0 gram per cubic centimetre. The aerosol-generating substrate may have a density between 0.4 grams per cubic centimetre and 1.0 grams per cubic centimetre. The aerosol-generating substrate may have a density between 0.4 grams per cubic centimetre and 0.9 grams per cubic centimetre. The aerosol-generating substrate may have a density between 0.5 grams per cubic centimetre and 0.9 grams per cubic centimetre.

The aerosol-generating article may have a resistance to draw (RTD) of less than or equal to 20 millimetre H₂O. The aerosol-generating article may have a resistance to draw (RTD) of less than or equal to 10 millimetre H₂O. The aerosol-generating article may have a resistance to draw (RTD) of less than or equal to 8 millimetre H₂O. The aerosol-generating article may have a resistance to draw (RTD) of less than or equal to 6 millimetre H₂O. The aerosol-generating article may have a resistance to draw (RTD) of less than or equal to 4 millimetre H₂O. The aerosol-generating article may have a resistance to draw (RTD) of less than or equal to 2 millimetre H₂O. The aerosol-generating article may have a resistance to draw (RTD) equal to, or close to, zero millimetres H₂O.

The aerosol-generating substrate may be deposited on the planar lower surface of the planar frame.

The aerosol-generating substrate may comprise at least two aerosol-generating segments. The at least two aerosol-generating segments may be spaced apart from each other. The at least two aerosol-generating segments may be spaced apart from each other in a longitudinal direction of the aerosol-generating article. The at least two aerosol-generating segments may be spaced apart from each other in a longitudinal direction of the planar frame to define a spacing gap. The airflow channel may pass between the spacing gap. The spacing gap may have a substantially constant depth along its length between the aerosol-generating segments. The spacing gap may be between 0.5 and 5 millimetres. Preferably, the spacing gap is between 0.5 and 2 millimetres.

The aerosol-generating substrate may comprise three aerosol-generating segments. A first and second of the three aerosol-generating segments may be spaced apart from each other in a longitudinal direction to define a first spacing gap. A second and third of the three aerosol-generating segments may be spaced apart from each other in a longitudinal direction to define a second spacing gap. The first and second spacing gaps may have substantially the same dimensions as each other.

The thickness of at least one aerosol-generating segment may be between about 0.1 millimetres and about 5 millimetres. The length of at least one aerosol-generating segment may be between about 10 millimetres and about 20 millimetres. The width of at least one aerosol-generating segment may be between about 10 millimetres and about 20 millimetres.

At least two of the aerosol-generating segments may differ from each other in terms of at least one of: size, shape, aerosol former content, bulk density, colour, texture (or more than one of these parameters). One of the at least two aerosol-generating segments may comprise a first aerosol-generating substrate. Another of the at least two aerosol-generating segments may comprise a second aerosol-generating substrate.

The first aerosol-generating substrate may have one or both of a lower aerosol former content and a lower bulk density than the second aerosol-generating substrate.

Two or more of the aerosol-generating segments may have the same shape, size, colour or texture (or more than one of these parameters) as each other. Two or more of the aerosol-generating segments may have the same top surface area as each other. This has the advantage of allowing flexibility in the selection and position of aerosol-generating segments by a user. Two or more of the aerosol-generating segments may have the same bottom surface area as each other. The bottom surface area may be closer to the base of the frame in use than the top surface area.

The aerosol-generating substrate may comprise polyhydric alcohols or mixtures thereof, such as propylene glycol, triethylene glycol, 1,3-butanediol, and glycerine. The aerosol-generating substrate may comprise plant based materials, such as loose tobacco or herbal fibers.

Suitable types of materials for use in the aerosol-generating substrate are described below and include, for example, tobacco cut filler, homogenised tobacco material such as cast leaf, aerosol-generating films and gel compositions.

Preferably, the aerosol-generating substrate comprises tobacco material. In certain preferred embodiments, the aerosol-generating substrate comprises shredded tobacco material. For example, the shredded tobacco material may be in the form of cut filler, as described in more detail below. Alternatively, the shredded tobacco material may be in the form of a shredded sheet of homogenised tobacco material. Suitable homogenised tobacco materials are described below. Within the context of the present specification, the term “cut filler” is used to describe to a blend of shredded plant material, such as tobacco plant material, including, in particular, one or more of leaf lamina, processed stems and ribs, homogenised plant material. The cut filler may also comprise other after-cut, filler tobacco or casing.

Preferably, the cut filler comprises at least 25 percent of plant leaf lamina, more preferably, at least 50 percent of plant leaf lamina, still more preferably at least 75 percent of plant leaf lamina and most preferably at least 90 percent of plant leaf lamina. Preferably, the plant material is one of tobacco, mint, tea and cloves. Most preferably, the plant material is tobacco. However, other plant material may be used, for example other plant material that has the ability to release substances upon the application of heat that can subsequently form an aerosol.

Preferably, the cut filler comprises tobacco plant material comprising lamina of one or more of bright tobacco, dark tobacco, aromatic tobacco and filler tobacco. The term “tobacco” may refer to any plant member of the genus Nicotiana.

In preferred embodiments, the weight of the cut filler is between 25 milligrams and 150 milligrams, preferably between 30 milligrams and 125 milligrams, more preferably between 40 milligrams and 100 milligrams. This amount of cut filler typically allows for sufficient material for the formation of an aerosol during the early puffs.

Preferably, the cut filler is soaked with the aerosol former. Soaking the cut filler can be done by spraying or by other suitable application methods. The aerosol former may be applied to the blend during preparation of the cut filler. For example, the aerosol former may be applied to the blend in the direct conditioning casing cylinder (DCCC). Conventional machinery can be used for applying an aerosol former to the cut filler. Suitable aerosol formers are set out above.

Preferably, the aerosol former in the cut filler comprises one or more of glycerol and propylene glycol. The aerosol former may consist of glycerol or propylene glycol or of a combination of glycerol and propylene glycol.

In other preferred embodiments, the aerosol-generating substrate comprises homogenised plant material, preferably a homogenised tobacco material. As used herein, the term “homogenised plant material” encompasses any plant material formed by the agglomeration of particles of plant. For example, sheets or webs of homogenised tobacco material for the aerosol-generating substrates may be formed by agglomerating particles of tobacco material obtained by pulverising, grinding or comminuting plant material and optionally one or more of tobacco leaf lamina and tobacco leaf stems. The homogenised plant material may be produced by casting, extrusion, paper making processes or other any other suitable processes known in the art. In some embodiments, the homogenised plant material may be in the form of one or more sheets. The homogenised plant material may be in the form of a plurality of pellets or granules. The homogenised plant material may be in the form of a plurality of strands, strips or shreds. The strands of homogenised plant material may be formed from a sheet of homogenised plant material, for example by cutting or shredding, or by other methods, for example, by an extrusion method.

The one or more sheets as described herein may each individually have a thickness of between 100 micrometres and 600 micrometres, preferably between 150 micrometres and 300 micrometres, and most preferably between 200 micrometres and 250 micrometres. Individual thickness refers to the thickness of the individual sheet, whereas combined thickness refers to the total thickness of all sheets that make up the aerosol-generating substrate.

The one or more sheets as described herein may have been one or more of crimped, folded, gathered and pleated.

The one or more sheets of homogenised plant material may be cut into strands as referred to above. In such embodiments, the aerosol-generating substrate comprises a plurality of strands of the homogenised plant material. The strands may be used to form a plug. Typically, the width of such strands is about 5 millimetres, or about 4 millimetres, or about 3 millimetres, or about 2 millimetres or less. The length of the strands may be greater than about 5 millimetres, between about 5 millimetres to about 15 millimetres, about 8 millimetres to about 12 millimetres, or about 12 millimetres. Preferably, the strands have substantially the same length as each other.

The homogenised plant material may comprise between 2.5 percent and 95 percent by weight of plant particles, or between 5 percent and 90 percent by weight of plant particles, or between 10 percent and 80 percent by weight of plant particles, or between 15 percent and 70 percent by weight of plant particles, or between 20 percent and 60 percent by weight of plant particles, or between 30 percent and 50 percent by weight of plant particles, on a dry weight basis. In certain embodiments, the homogenised plant material is a homogenised tobacco material comprising tobacco particles. Sheets of homogenised tobacco material for use in such embodiments may have a tobacco content of at least about 40 percent by weight on a dry weight basis, more preferably of at least about 50 percent by weight on a dry weight basis more preferably at least about 70 percent by weight on a dry weight basis and most preferably at least about 90 percent by weight on a dry weight basis.

The term “tobacco particles” may describe particles of any plant member of the genus Nicotiana. The term “tobacco particles” encompasses ground or powdered tobacco leaf lamina, ground or powdered tobacco leaf stems, tobacco dust, tobacco fines, and other particulate tobacco by-products formed during the treating, handling and shipping of tobacco. In a preferred embodiment, the tobacco particles are substantially all derived from tobacco leaf lamina. By contrast, isolated nicotine and nicotine salts are compounds derived from tobacco but are not considered tobacco particles for purposes of this disclosure and are not included in the percentage of particulate plant material.

The aerosol-generating substrate may comprise nicotine. As used herein, the term “nicotine” is used to describe nicotine, a nicotine base or a nicotine salt. In embodiments in which the aerosol-generating substrate comprises a nicotine base or a nicotine salt, the amounts of nicotine recited herein are the amount of free base nicotine or amount of protonated nicotine, respectively.

The aerosol-generating substrate may comprise between 0.5 percent and 10 percent by weight of nicotine, or between 1 percent and 8 percent by weight of nicotine, or between 2 percent and 6 percent by weight of nicotine, on a dry weight basis.

The aerosol-generating substrate may be substantially tobacco free.

Preferably, the aerosol-generating substrate is in the form of an aerosol-generating film comprising a cellulosic based film forming agent, nicotine and the aerosol former. The aerosol-generating film may further comprise a cellulose based strengthening agent. The aerosol-generating film may further comprise water, preferably 30 percent by weight or less of water.

The term “cellulose based film-forming agent” is used to describe a cellulosic polymer capable, by itself or in the presence of an auxiliary thickening agent, of forming a continuous film. Preferably, the cellulose based film-forming agent is selected from the group consisting of hydroxypropyl methylcellulose (HPMC), methylcellulose (MC), ethylcellulose (EC), hydroxyethyl methyl cellulose (HEMC), hydroxyethyl cellulose (HEC), hydroxypropyl cellulose (HPC), and combinations thereof. More preferably, the cellulose based film-forming agent is selected from the group consisting of hydroxypropyl methylcellulose (HPMC), methylcellulose (MC), ethylcellulose (EC), and combinations thereof.

Preferably, the aerosol-generating film further comprises a cellulose based strengthening agent. Preferably, the cellulose based strengthening agent is selected from the group consisting of cellulose fibres, microcrystalline cellulose (MCC), cellulose powder, and combinations thereof.

The aerosol-generating film may have a cellulose based strengthening agent content of between 0.5 percent and 40 percent by weight on a dry weight basis, or between 5 percent and 30 percent by weight on a dry weight basis, or between 10 percent and 25 percent by weight on a dry weight basis.

The aerosol-generating film may further comprise a carboxymethyl cellulose, preferably sodium carboxymethyl cellulose.

The aerosol-generating film may have a carboxymethyl cellulose content of between 1 percent and 15 percent by weight, or between 2 percent and 12 percent by weight, or between 4 percent and 10 percent by weight on a dry weight basis.

The aerosol-generating film preferably comprises nicotine.

In embodiments in which the aerosol-generating film comprises a nicotine base or a nicotine salt, the amounts of nicotine recited herein are the amount of free base nicotine or amount of protonated nicotine, respectively.

The aerosol-generating film may comprise natural nicotine or synthetic nicotine.

The aerosol-generating film may comprise one or more monoprotic nicotine salts.

As used herein, the term “monoprotic nicotine salt” is used to describe a nicotine salt of a monoprotic acid.

Preferably, the aerosol-generating film comprises at least 0.5 percent by weight of nicotine on a dry weight basis. More preferably, the aerosol-generating film comprises at least 1 percent by weight of nicotine on a dry weight basis. Even more preferably, the aerosol-generating film comprises at least 2 percent by weight of nicotine on a dry weight basis. In addition, or as an alternative, the aerosol-generating film preferably comprises less than 10 percent by weight of nicotine on a dry weight basis. More preferably, the aerosol-generating film comprises less than 8 percent by weight of nicotine on a dry weight basis. More preferably, the aerosol-generating film comprises less than 6 percent by weight of nicotine on a dry weight basis.

For example, the aerosol-generating film may comprise between 0.5 percent and 10 percent by weight of nicotine, or between 1 percent and 8 percent by weight of nicotine, or between 2 percent and 6 percent by weight of nicotine, on a dry weight basis.

The aerosol-generating film may be a substantially tobacco-free aerosol-generating film.

In preferred embodiments, the aerosol-generating film comprises an acid. More preferably, the aerosol-generating film comprises one or more organic acids. Even more preferably, the aerosol-generating film comprises one or more carboxylic acids. In particularly preferred embodiments, the acid is lactic acid, benzoic acid, fumaric acid or levulinic acid.

Preferably, the aerosol-generating film comprises between 0.25 percent and 3.5 percent by weight of an acid, or between 0.5 percent and 3 percent by weight of an acid, or between 1 percent and 2.5 percent by weight of an acid, on a dry weight basis.

The aerosol-generating film may have a thickness from about 0.1 millimetres to about 1 millimetre, more preferably from about 0.1 millimetres to about 0.75 millimetres, even more preferably from about 0.1 millimetres to about 0.5 millimetres. In particularly preferred embodiments, a layer of the film-forming composition is formed that has a thickness from about 50 micrometres to 400 micrometres, more preferably from about 100 micrometres to 200 micrometres.

The aerosol-generating film may optionally be provided within the second aerosol-generating segment on a suitable carrier element.

In alternative embodiments, the second aerosol-generating substrate may comprise a gel composition that includes nicotine, at least one gelling agent and the aerosol former. The gel composition is preferably substantially tobacco free.

The preferred weight ranges for nicotine in the gel composition are the same as those defined above in relation to aerosol-generating films.

The gel composition preferably comprises at least 50 percent by weight of aerosol former, more preferably at least 60 percent by weight, more preferably at least 70 percent by weight of aerosol former, on a dry weight basis. The gel composition may comprise up to 80 percent by weight of aerosol former. The aerosol former in the gel composition is preferably glycerol.

The gel composition preferably includes at least one gelling agent. Preferably, the gel composition includes a total amount of gelling agents in a range from about 0.4 percent by weight to about 10 percent by weight, or from about 0.5 percent by weight to about 8 percent by weight, or from about 1 percent by weight to about 6 percent by weight, or from about 2 percent by weight to about 4 percent by weight, or from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The term “hydrogen-bond crosslinking gelling agent” refers to a gelling agent that forms non-covalent crosslinking bonds or physical crosslinking bonds via hydrogen bonding.

The hydrogen-bond crosslinking gelling agent may include one or more of a galactomannan, gelatin, agarose, or konjac gum, or agar. The hydrogen-bond crosslinking gelling agent may preferably include agar.

The term “ionic crosslinking gelling agent” refers to a gelling agent that forms non-covalent crosslinking bonds or physical crosslinking bonds via ionic bonding.

The ionic crosslinking gelling agent may include low acyl gellan, pectin, kappa carrageenan, iota carrageenan or alginate. The ionic crosslinking gelling agent may preferably include low acyl gellan.

The gelling agent may include one or more biopolymers. The biopolymers may be formed of polysaccharides.

Biopolymers include, for example, gellan gums (native, low acyl gellan gum, high acyl gellan gums with low acyl gellan gum being preferred), xanthan gum, alginates (alginic acid), agar, guar gum, and the like. The composition may preferably include xanthan gum. The composition may include two biopolymers. The composition may include three biopolymers. The composition may include the two biopolymers in substantially equal weights. The composition may include the three biopolymers in substantially equal weights.

The gel composition may further include a viscosifying agent. The viscosifying agent combined with the hydrogen-bond crosslinking gelling agent and the ionic crosslinking gelling agent appears to surprisingly support the solid medium and maintain the gel composition even when the gel composition comprises a high level of glycerol.

The term “viscosifying agent” refers to a compound that, when added homogeneously into a 25° C., 50 percent by weight water/50 percent by weight glycerol mixture, in an amount of 0.3 percent by weight., increases the viscosity without leading to the formation of a gel, the mixture staying or remaining fluid.

The gel composition preferably includes the viscosifying agent in a range from about 0.2 percent by weight to about 5 percent by weight, or from about 0.5 percent by weight to about 3 percent by weight, or from about 0.5 percent by weight to about 2 percent by weight, or from about 1 percent by weight to about 2 percent by weight.

The viscosifying agent may include one or more of xanthan gum, carboxymethyl-cellulose, microcrystalline cellulose, methyl cellulose, gum Arabic, guar gum, lambda carrageenan, or starch. The viscosifying agent may preferably include xanthan gum.

The gel composition may further include a divalent cation. Preferably the divalent cation includes calcium ions, such as calcium lactate in solution. Divalent cations (such as calcium ions) may assist in the gel formation of compositions that include gelling agents such as the ionic crosslinking gelling agent, for example. The ion effect may assist in the gel formation. The divalent cation may be present in the gel composition in a range from about 0.1 to about 1 percent by weight, or about 0.5 percent by weight t.

The gel composition may further include an acid. The acid may comprise a carboxylic acid. The carboxylic acid may include a ketone group. Preferably the carboxylic acid may include a ketone group having less than about 10 carbon atoms, or less than about 6 carbon atoms or less than about 4 carbon atoms, such as levulinic acid or lactic acid. Preferably this carboxylic acid has three carbon atoms (such as lactic acid).

The gel composition preferably comprises some water. The gel composition is more stable when the composition comprises some water.

Preferably the gel composition comprises between about 8 percent by weight to about 32 percent by weight water, or from about 15 percent by weight to about 25 percent by weight water, or from about 18 percent by weight to about 22 percent by weight water, or about 20 percent by weight water.

Preferably, where a gel composition is used, the second aerosol-generating substrate comprises a porous medium loaded with the gel composition. Advantages of a porous medium loaded with the gel composition is that the gel composition is retained within the porous medium, and this may aid manufacturing, storage or transport of the gel composition. It may assist in keeping the desired shape of the gel composition, especially during manufacture, transport, or use.

The term “porous” is used herein to refer to a material that provides a plurality of pores or openings that allow the passage of air through the material.

The porous medium may be any suitable porous material able to hold or retain the gel composition. Ideally the porous medium can allow the gel composition to move within it. In specific embodiments the porous medium comprises natural materials, synthetic, or semi-synthetic, or a combination thereof. In specific embodiments the porous medium comprises sheet material, foam, or fibres, for example loose fibres; or a combination thereof. In specific embodiments the porous medium comprises a woven, non-woven, or extruded material, or combinations thereof. Preferably the porous medium comprises, cotton, paper, viscose, PLA, or cellulose acetate, of combinations thereof. Preferably the porous medium comprises a sheet material, for example, cotton or cellulose acetate. In a particularly preferred embodiment, the porous medium comprises a sheet made from cotton fibres. The porous medium may be crimped or shredded. The porous medium may be in the form of a sheet, thread or tubular element.

The aerosol-generating substrate may be flat. The aerosol-generating substrate may be planar. This has the advantage of allowing the aerosol-generating substrate to be efficiently heated by a heating element, and improving the yield of aerosol generated from the aerosol-generating substrate. By having a large surface area to volume ratio, and by having a reduced thickness compared to its length and width, a heating element can be located such that all of the aerosol-generating substrate is within a specified distance from the heating element. This has the advantage of providing an improved user experience and reducing wasted aerosol-generating substrate in use.

The aerosol-generating substrate may be substantially aligned with the planar frame. A plane in which the aerosol-generating substrate extends may be substantially aligned with or substantially parallel to a plane in which the planar frame extends.

The aerosol-generating substrate may have a thickness which is less than the frame thickness. The aerosol-generating substrate may be disposed on an adhesive. The combined thickness of the adhesive and the aerosol-generating substrate may be less than the frame thickness. The aerosol-generating substrate may have a thickness which is less than the perimeter wall thickness. The aerosol-generating substrate may be disposed on an adhesive, and the combined thickness of the adhesive and the aerosol-generating substrate may be less than the perimeter wall thickness. The aerosol-generating substrate may have a thickness such that when the aerosol-generating substrate is disposed in the aerosol-generating cavity, there is an air gap between an upper surface of the aerosol-generating substrate and an upper surface of the frame. When the aerosol-generating substrate is disposed in the aerosol-generating cavity, there may be an air gap between an upper surface of the aerosol-generating substrate and an upper surface of the perimeter wall.

The aerosol-generating article may comprise adhesive configured to attach the aerosol-generating substrate to the frame. The adhesive may comprise two or more regions of adhesive. The adhesive may be polyvinyl acetate.

The aerosol-generating substrate may comprise a first aerosol-generating segment. The first aerosol-generating segment may comprise a first aerosol-generating substrate. The aerosol-generating substrate may comprise a second aerosol-generating segment. The second aerosol-generating segment may comprise a second aerosol-generating substrate. The first aerosol-generating substrate may have one or both of a lower aerosol former content and a lower bulk density than the second aerosol-generating substrate. At least a portion of the second aerosol-generating segment may be located at a location upstream of at least a portion of the first aerosol-generating segment.

The first and second aerosol-generating substrates may comprise the same aerosol former or aerosol formers as each other, or different aerosol formers may be used.

The aerosol-generating article may be provided in an aerosol-generating system. The aerosol-generating system may comprise an aerosol-generating device. The aerosol-generating device may comprise a heating element.

According to the disclosure there is provided an aerosol-generating system for forming an inhalable aerosol. The aerosol-generating system may comprise an aerosol-generating article and an aerosol-generating device. The aerosol-generating article may comprise a planar frame. The planar frame may comprise a planar lower surface. The planar frame may comprise lateral sides. The aerosol-generating article may comprise an air inlet. The aerosol-generating article may comprise an aerosol outlet. The aerosol-generating article may comprise an aerosol-generating substrate. The aerosol-generating substrate may be in contact with the planar lower surface of the planar frame. The aerosol-generating device may comprise a heating element. The heating element may be configured to heat the aerosol-generating substrate to form an aerosol. The aerosol-generating device may comprise a device housing. The device housing may comprise a planar inner surface. The aerosol-generating article may be configured for insertion into the device. The aerosol-generating article may be configured for insertion into the device to form an aerosolisation cavity. The aerosolisation cavity may be between the planar lower surface of the planar frame and the inner surface of the device. The aerosol-generating substrate may be disposed in the aerosolisation cavity. The aerosol-generating substrate may be spaced from the inner surface. The aerosol-generating substrate may be spaced from the inner surface to define an air gap between an upper surface of the aerosol-generating substrate and the inner surface of the device. The aerosol-generating article may be configured for insertion into the device to form an airflow channel extending from the air inlet to the aerosol outlet. The airflow channel may pass through the air gap between the upper surface of the aerosol-generating substrate and the inner surface of the device.

According to the disclosure there is provided an aerosol-generating system for forming an inhalable aerosol, comprising an aerosol-generating article and an aerosol-generating device;
the aerosol-generating article comprising:
   a planar frame comprising a planar lower surface and lateral sides,
   an air inlet and an aerosol outlet, and
   an aerosol-generating substrate in contact with the planar lower surface of the planar frame; and
the device comprising:
   a heating element configured to heat the aerosol-generating substrate to form an aerosol, and
   a device housing having a planar inner surface;
wherein the aerosol-generating article is configured for insertion into the device to form:
an aerosolisation cavity between the planar lower surface of the planar frame and the inner surface of the device, the aerosol-generating substrate being disposed in the aerosolisation cavity spaced from the inner surface to define an air gap between an upper surface of the aerosol-generating substrate and the inner surface of the device; and
an airflow channel extending from the air inlet to the aerosol outlet, passing through the air gap between the upper surface of the aerosol-generating substrate and the inner surface of the device.

The aerosol-generating article of the aerosol-generating system may comprise any of the aerosol-generating article features described herein.

The aerosol-generating substrate may have a planar upper surface and a planar lower surface. The heating element may be arranged proximate to the planar lower surface of the aerosol-generating substrate. The aerosol-generating substrate may be arranged so that volatile compounds which form aerosol leaving the aerosol-generating substrate leave the upper surface of the aerosol-generating substrate, into the air gap. The aerosol-generating substrate may be arranged so that aerosol leaves the aerosol-generating substrate in a direction perpendicular to the upper surface of the aerosol-generating substrate.

The aerosol-generating article may be configured to removably connect to an aerosol-generating device. The aerosol-generating article may be sized or shaped (or sized and shaped) to removably connect to an aerosol-generating device.

The aerosol-generating device may have a device housing defining a cavity. The aerosol-generating article may be disposed in the device housing cavity.

The heating element may be substantially planar. The heating element may be substantially aligned with the aerosol-generating substrate. A plane of the heating element may be substantially aligned with or substantially parallel to a plane of the aerosol-generating substrate.

The aerosol-generating system may comprise a plurality of heating elements. The aerosol-generating system may comprise a number of heating elements which is the same as the number of aerosol-generating substrate segments of the aerosol-generating article. The aerosol-generating system may be configured in use to heat the aerosol-generating substrate up to a temperature of approximately 250 degrees Celsius.

The aerosol-generating article may be configured to be wholly or partially inserted into the aerosol-generating device.

The invention is defined in the claims. However, below there is provided a non-exhaustive list of non-limiting examples. Any one or more of the features of these examples may be combined with any one or more features of another example, embodiment, or aspect described herein.

Example Ex 1. An aerosol-generating article for use with an aerosol-generating device to form an inhalable aerosol, the aerosol-generating article comprising:
a planar frame comprising a planar upper surface, a planar lower surface and lateral sides extending between the planar upper surface and the planar lower surface;
an air inlet and an aerosol outlet;
an aerosolisation cavity between the air inlet and the aerosol outlet;
an aerosol-generating substrate located in the aerosolisation cavity, in contact with the planar lower surface of the planar frame and spaced from the planar upper surface of the planar frame to define an air gap between an upper surface of the aerosol-generating substrate and the planar upper surface of the planar frame; and
an airflow channel extending from the air inlet to the aerosol outlet, passing through the air gap.

Example Ex 2. An aerosol-generating article according to Example Ex 1, wherein the airflow channel passes between the aerosol-generating substrate and at least one of the lateral sides of the planar frame.

Example Ex 3. An aerosol-generating article according to Example Ex 1 or Example Ex 2, wherein the airflow channel passes between the aerosol-generating substrate and at least two opposing lateral sides of the planar frame.

Example Ex 4. An aerosol-generating article according to any of Examples Ex 1 to Ex 3, wherein the aerosol-generating substrate has an outer surface, and at least 50% of the outer surface of the aerosol-generating substrate is in contact with the airflow channel.

Example Ex 5. An aerosol-generating article according to any of Examples Ex 1 to Ex 4, wherein the aerosol-generating substrate has an outer surface, and at least 60% of the outer surface of the aerosol-generating substrate is in contact with the airflow channel.

Example Ex 6. An aerosol-generating article according to any of Examples Ex 1 to Ex 5, wherein the air gap has a depth of approximately 0.2 millimetres, preferably approximately 0.5 millimetres.

Example Ex 7. An aerosol-generating article according to any of Examples Ex 1 to Ex 6, wherein the air gap extends over substantially all of the upper surface of the aerosol-generating substrate.

Example Ex 8. An aerosol-generating article according to any of Examples Ex 1 to Ex 7, wherein the air gap has a substantially constant depth over the upper surface of the aerosol-generating substrate.

Example Ex 9. An aerosol-generating article according to any of Examples Ex 1 to Ex 8, wherein the airflow channel has a depth between the planar upper surface and the planar lower surface of the planar frame, the depth being between about 0.3 millimetres and about 5.5 millimetres.

Example Ex 10. An aerosol-generating article according to any of Examples Ex 1 to Ex 9, wherein the airflow channel has a width between opposing lateral sides of the planar frame, the width being between 5 millimetres and 15 millimetres.

Example Ex 11. An aerosol-generating article according to any of Examples Ex 1 to Ex 10, wherein the aerosolisation cavity has a width between opposing lateral sides of the planar frame, the width being between 5 millimetres and 15 millimetres.

Example Ex 12. An aerosol-generating article according to any of Examples Ex 1 to Ex 11, wherein the aerosolisation cavity has a length between 15 millimetres and 45 millimetres.

Example Ex 13. An aerosol-generating article according to any of Examples Ex 1 to Ex 12, wherein the aerosol-generating substrate has a thickness between about 0.1 millimetres and about 5 millimetres.

Example Ex 14. An aerosol-generating article according to any of Examples Ex 1 to Ex 13, wherein the aerosol-generating substrate has a width between about 10 millimetres and about 20 millimetres.

Example Ex 15. An aerosol-generating article according to any of Examples Ex 1 to Ex 14, wherein the aerosol-generating substrate has a length between about 20 millimetres and about 40 millimetres.

Example Ex 16. An aerosol-generating article according to any of Examples Ex 1 to Ex 15, wherein the aerosol-generating substrate comprises at least two aerosol-generating segments.

Example Ex 17. An aerosol-generating article according to Example Ex 16, wherein the at least two aerosol-generating segments are spaced apart from each other in a longitudinal direction of the planar frame to define a spacing gap, and the airflow channel passes through the spacing gap.

Example Ex 18. An aerosol-generating article according to Example Ex 16 or Example Ex 17, wherein the thickness of at least one aerosol-generating segment is between about 0.1 millimetres and about 5 millimetres.

Example Ex 19. An aerosol-generating article according to any of Examples Ex 16 to Ex 18, wherein the length of at least one aerosol-generating segment is between about 10 millimetres and about 20 millimetres.

Example Ex 20. An aerosol-generating article according to any of Examples Ex 16 to Ex 19, wherein the width of at least one aerosol-generating segment is between about 10 millimetres and about 20 millimetres.

Example Ex 21. An aerosol-generating article according to any of Examples Ex 16 to Ex 20, wherein at least two of the aerosol-generating segments differ from each other in terms of at least one of: size, shape, aerosol former content, bulk density.

Example Ex 22. An aerosol-generating article according to any of Examples Ex 1 to Ex 21, wherein one of the at least two aerosol-generating segments comprises a first aerosol-generating substrate, and one other of the at least two aerosol-generating segments comprises a second aerosol-generating substrate, and the first aerosol-generating substrate has one or both of a lower aerosol former content and a lower bulk density than the second aerosol-generating substrate.

Example Ex 23. An aerosol-generating article according to any of Examples Ex 1 to Ex 22, wherein the aerosol-generating substrate comprises three aerosol-generating segments. Example Ex 24. An aerosol-generating article according to any of Examples Ex 1 to Ex 23, wherein the aerosol-generating substrate has a bulk density of between 0.5 grams per cubic centimetre and 0.9 grams per cubic centimetre.

Example Ex 25. An aerosol-generating article according to any of Examples Ex 1 to Ex 24, wherein the aerosol-generating substrate has a resistance to draw of less than or equal to 20 millimetre H₂O.

Example Ex 26. An aerosol-generating system comprising an aerosol-generating device and the aerosol-generating article of any of Examples Ex 1 to Ex 25, the aerosol-generating device comprising a heating element.

Example Ex 27. An aerosol-generating system for forming an inhalable aerosol, comprising an aerosol-generating article and an aerosol-generating device;
the aerosol-generating article comprising:
   a planar frame comprising a planar lower surface and lateral sides,
   an air inlet and an aerosol outlet, and
   an aerosol-generating substrate in contact with the planar lower surface of the planar frame; and
the device comprising:
   a heating element configured to heat the aerosol-generating substrate to form an aerosol, and
   a device housing having a planar inner surface;
wherein the aerosol-generating article is configured for insertion into the device to form:
an aerosolisation cavity between the planar lower surface of the planar frame and the inner surface of the device, the aerosol-generating substrate being disposed in the aerosolisation cavity spaced from the inner surface to define an air gap between an upper surface of the aerosol-generating substrate and the inner surface of the device; and
an airflow channel extending from the air inlet to the aerosol outlet, passing through the air gap between the upper surface of the aerosol-generating substrate and the inner surface of the device.

Example Ex 28. An aerosol-generating article or system according to any of Examples Ex 1 to Ex 27, wherein the planar frame has a width, a depth and a length, the length being greater than the width, and the width being greater than the depth.

Example Ex 29. An aerosol-generating article or system according to any of Examples Ex 1 to Ex 28, wherein the planar frame has a length, a width, and a thickness, the thickness being no more than 0.5 times the length and no more than 0.5 times the width.

Example Ex 30. An aerosol-generating article or system according to any of Examples Ex 1 to Ex 27, wherein the air inlet is disposed on a first lateral side of the planar frame, and the aerosol outlet is disposed on the proximal end of the planar frame.

Examples will now be further described with reference to the figures in which:

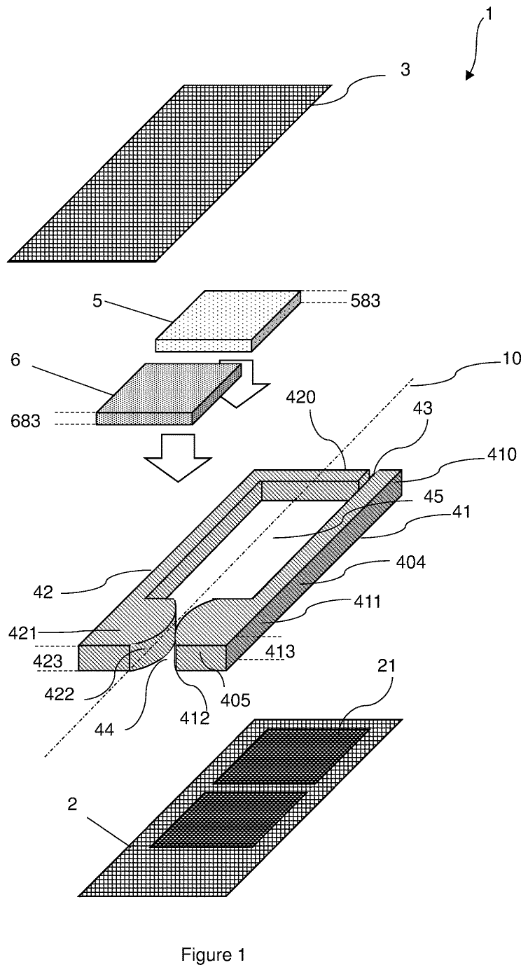

FIG. 1 shows a schematic expanded view illustration of an aerosol-generating article according to this disclosure;

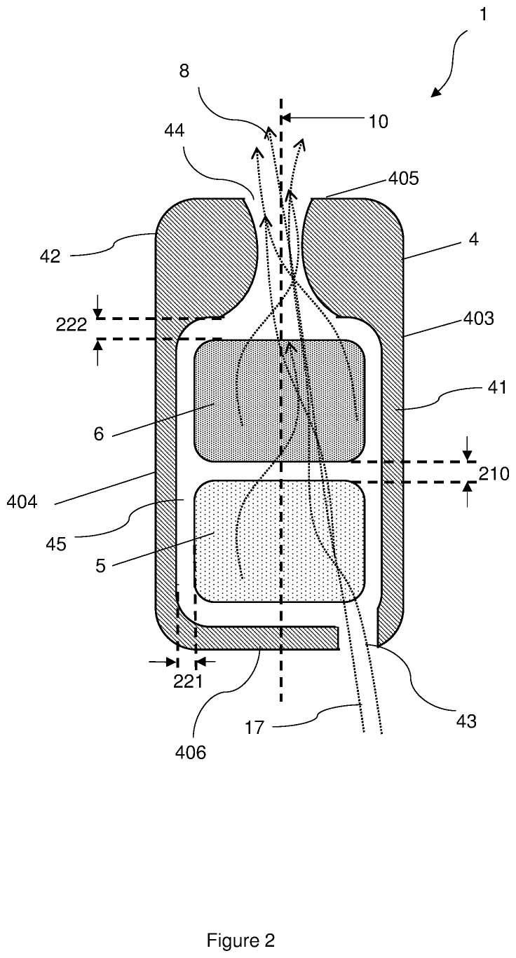

FIG. 2 shows a cross-sectional schematic illustration of an aerosol-generating article according to this disclosure;

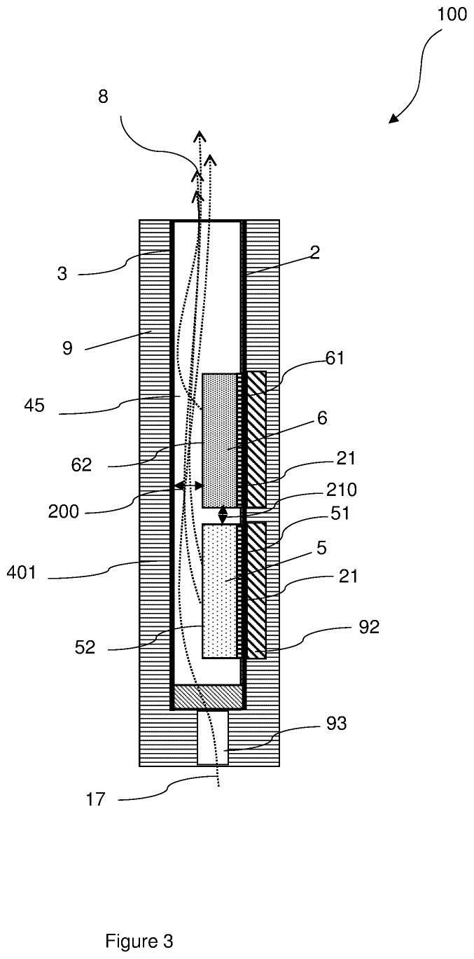

FIG. 3 shows a cross-sectional schematic illustration of an aerosol-generating article according to this disclosure;

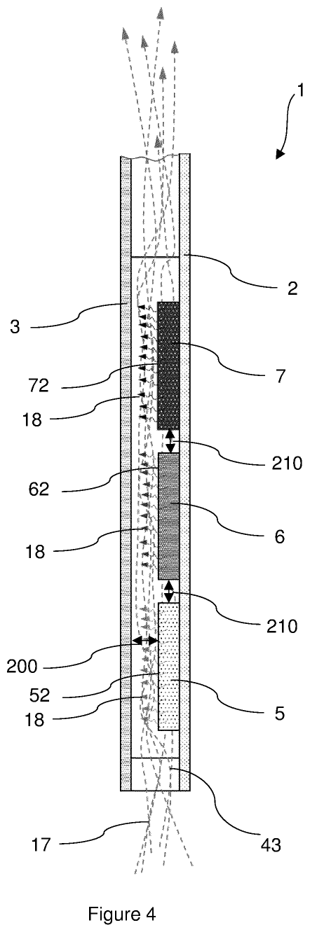

FIG. 4 shows a cross-sectional schematic illustration of an aerosol-generating system according to this disclosure; and

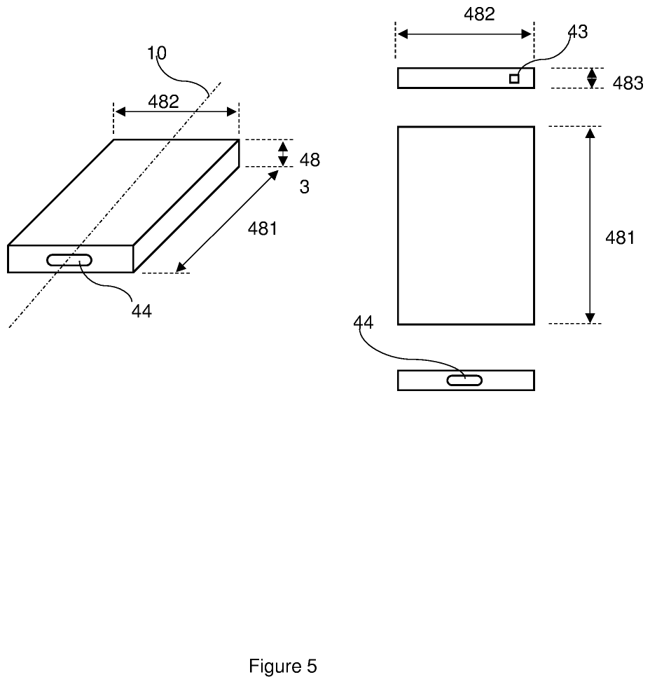

FIG. 5 shows a cross-sectional schematic illustration of an aerosol-generating article according to this disclosure with labelled dimensions.

FIG. 1 shows an expanded view of an aerosol-generating article 1 according to this disclosure. The aerosol-generating article 1 is for use with an aerosol-generating device to form an inhalable aerosol. The aerosol-generating article 1 is a generally flat, planar article, with a rectangular transverse cross-sectional shape.

The aerosol-generating device 1 comprises a planar frame and an aerosol-generating substrate 5, 6. The aerosol-generating substrate 5, 6 is in two segments. The aerosol-generating substrate 5, 6 comprises a first aerosol-generating segment comprising a first aerosol-generating substrate 5 and a second aerosol-generating segment comprising a second aerosol-generating substrate 6.

The planar frame comprises an upper planar surface 3, a lower planar surface 2 and lateral sides 403, 404, 405, 406. The lateral sides 403, 404, 405, 406 together form a perimeter wall 41, 42.

The planar frame comprises an air inlet 43 disposed on a lateral side 406. The planar frame comprises an aerosol outlet 44 disposed on a lateral side 405 opposing the air inlet 43. The planar frame comprises an aerosolisation cavity 45 between the air inlet 43 and the aerosol outlet 44. The aerosol-generating substrate 5, 6 is disposed in the aerosolisation cavity 45.

The lower planar surface 2 and the perimeter wall 41, 42 define the aerosolisation cavity 45. The perimeter wall 41, 42 comprises cellulose material. The perimeter wall 41, 42 comprises a biodegradable material. The planar lower surface 2 comprises two regions of adhesive 21 onto which the two aerosol-generating segments 5, 6 can be fixed. A lower surface 51, 61 of the aerosol-generating segments is fixed to the planar lower surface 2 via adhesive, as best seen in FIG. 3.

The air inlet 43 and the aerosol outlet 44 are apertures disposed in the perimeter wall 41, 42. The perimeter wall 41, 42 comprises a first section 41 and a second section 42, separated from each other by the inlet 43 and the outlet 44. The first and second sections 41, 42 each have a convex portion at a downstream end, the convex portions facing each other. The first section 41 is substantially L-shaped. The first section 41 extends wholly along one lateral side 403 and partially along another lateral side 405 of the frame. The second section is substantially U-shaped. The second section 42 extends wholly along one lateral side 404 and partially along two other lateral sides 405, 406 of the frame. The first and second sections 41, 42 are co-planar. The aerosolisation cavity 45 is defined between the first and second sections 41, 42.

An aerosol-generating system 100 is shown in FIG. 3. An aerosol-generating article 1 is shown in FIG. 4. The aerosol-generating article 1 of FIG. 4 is the same as the aerosol-generating article 1 described in relation to FIGS. 1 to 3, but it differs by comprising an additional aerosol-generating segment 7.

As shown in FIGS. 1 and 2, the aerosol-generating substrate 5, 6, 7 of the aerosol-generating article 1 shown throughout the figures, is planar. The aerosol-generating substrate 5, 6 has a thickness 583, 683. The perimeter wall 41, 42 has a thickness 413, 423. The aerosol-generating substrate thickness 583, 683 is less than the perimeter wall thickness 413, 423. As shown in FIGS. 3 and 4, this allows for an air gap 200 to be defined between the upper planar surface 3 and the aerosol-generating substrate 5, 6, 7. This allows for an airflow channel extending from the air inlet to the aerosol outlet, passing through the air gap 200.

With reference to FIG. 3, the aerosol-generating system 100 comprises an aerosol-generating device 9. The aerosol-generating device 9 comprises a device cavity into which the aerosol-generating article 1 is inserted, an air inlet 93 and a heating element 92.

In an assembled state, the aerosol-generating substrate 5, 6, is proximate to a heating element 92 of the aerosol-generating device.

In use, when a user draws on the aerosol-outlet 44, air flow 17 moves through the air inlet 93, through the air inlet 43 of the aerosol-generating article, over the heated aerosol-generating substrate 5, 6. Specifically, air flows over an upper surface 52, 62, 72 of the aerosol-generating substrate 5, 6. A lower surface of the aerosol-generating substrate 5, 6 is heated by the heating element 92 and an aerosol is generated and leaves the upper surface 52, 62, 72 which is picked up by air flow 17 and passes to the outlet 44 as airflow containing aerosol 8. This can also be seen in FIG. 4, in which aerosol generation into the air gap 200 depicted by arrows 18 is shown.

The aerosol-generating segments 5, 6, 7 are spaced apart from each other in a longitudinal direction of the planar frame to define a spacing gap 210 or spacing gaps 210 between neighbouring aerosol-generating segments 5, 6, 7. The airflow channel can pass through the spacing gap 210 or spacing gaps 210.

As best seen in FIG. 2, there is also a lateral gap 221, 222 between the lateral side walls and an outer edge of the aerosol-generating substrate 5, 6. The airflow channel can pass through the lateral gap 221, 222.

As shown in FIG. 5, the planar frame has a frame length 481 along a longitudinal axis 10. The planar frame is elongate along the frame length 481. The air inlet 43 and the aerosol outlet 44 are disposed on opposite ends of the frame length 481. The planar frame has a frame width 482. The planar frame has a frame thickness 483.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating article for an aerosol-generating device to form an inhalable aerosol, the aerosol-generating article comprising:
a planar frame comprising a planar upper surface, a planar lower surface, and lateral sides extending between the planar upper surface and the planar lower surface;
an air inlet and an aerosol outlet;
an aerosolisation cavity between the air inlet and the aerosol outlet;
an aerosol-generating substrate located in the aerosolisation cavity, in contact with the planar lower surface of the planar frame and spaced from the planar upper surface of the planar frame to define an air gap between an upper surface of the aerosol-generating substrate and the planar upper surface of the planar frame, wherein the air gap has a depth of between approximately 0.1 millimetre and approximately 1 millimetre, and wherein the air gap extends over substantially all of the upper surface of the aerosol-generating substrate; and
an airflow channel extending from the air inlet to the aerosol outlet, passing through the air gap.

17. The aerosol-generating article according to claim 16, wherein the airflow channel passes between the aerosol-generating substrate and at least one of the lateral sides of the planar frame.

18. The aerosol-generating article according to claim 16, wherein the airflow channel passes between the aerosol-generating substrate and at least two opposing lateral sides of the planar frame.

19. The aerosol-generating article according to claim 16, wherein the aerosol-generating substrate has an outer surface, and at least 50% of the outer surface of the aerosol-generating substrate is in contact with the airflow channel.

20. The aerosol-generating article according to claim 16, wherein the air gap has a depth of approximately 0.2 millimetre.

21. The aerosol-generating article according to claim 16, wherein the air gap has a depth of approximately 0.5 millimetre.

22. The aerosol-generating article according to claim 16, wherein the airflow channel has a depth between the planar upper surface and the planar lower surface of the planar frame, the depth being between about 0.3 millimetre and about 5.5 millimetres.

23. The aerosol-generating article according to claim 16, wherein the airflow channel has a width between opposing lateral sides of the planar frame, the width being between 5 millimetres and 15 millimetres.

24. The aerosol-generating article according to claim 16, wherein the aerosol-generating substrate has a thickness between about 0.1 millimetre and about 5 millimetres.

25. The aerosol-generating article according to claim 16, wherein the aerosol-generating substrate comprises at least two aerosol-generating segments.

26. The aerosol-generating article according to claim 25, wherein the at least two aerosol-generating segments are spaced apart from each other in a longitudinal direction of the planar frame to define a spacing gap, and the airflow channel passes through the spacing gap.

27. The aerosol-generating article according to claim 16, wherein the aerosol-generating substrate has a bulk density of between 0.5 gram per cubic centimetre and 0.9 gram per cubic centimetre.

28. The aerosol-generating article according to claim 16, wherein the aerosol-generating substrate has a resistance to draw of less than or equal to 20 millimetres H₂O.

29. An aerosol-generating system comprising an aerosol-generating device and the aerosol-generating article according to claim 16, the aerosol-generating device comprising a heating element.

30. An aerosol-generating system for forming an inhalable aerosol, comprising an aerosol-generating article and an aerosol-generating device,
the aerosol-generating article comprising:
a planar frame comprising a planar lower surface and lateral sides,
an air inlet and an aerosol outlet, and
an aerosol-generating substrate in contact with the planar lower surface of the planar frame; and
the aerosol-generating device comprising:
a heating element configured to heat the aerosol-generating substrate to form an aerosol, and
a device housing having a planar inner surface,
wherein the aerosol-generating article is configured for insertion into the aerosol-generating device to form:
an aerosolisation cavity between the planar lower surface of the planar frame and the planar inner surface of the device, the aerosol-generating substrate being disposed in the aerosolisation cavity spaced from the planar inner surface to define an air gap between an upper surface of the aerosol-generating substrate and the planar inner surface of the device, wherein the air gap has a depth of between approximately 0.1 millimetre and approximately 1 millimetre, and wherein the air gap extends over substantially all of the upper surface of the aerosol-generating substrate, and
an airflow channel extending from the air inlet to the aerosol outlet, passing through the air gap between the upper surface of the aerosol-generating substrate and the planar inner surface of the device.
